(19) United States
(12) Patent Application Publication
(10) Pub. No.: US 2017/0192291 A1
(43) Pub. Date: Jul. 6, 2017

(54) DISPLAY DEVICE AND MANUFACTURING METHOD THEREOF

(71) Applicant: NUBIA TECHNOLOGY CO., LTD., Shenzhen (CN)

(72) Inventor: Jiecheng Shi, Shenzhen (CN)

(21) Appl. No.: 15/438,540

(22) Filed: Feb. 21, 2017

Related U.S. Application Data
(63) Continuation of application No. PCT/CN2015/087387, filed on Aug. 18, 2015.

(30) Foreign Application Priority Data
Aug. 22, 2014 (CN) 201410419874.0
Aug. 13, 2015 (CN) 201510496332.8

(51) Int. Cl. G02F 1/1333

(52) U.S. Cl. CPC G02F 1/133308; G02F 1/13338; G02F 2001/133317; G02F 2001/133331; G02F 2001/133325

(57) ABSTRACT

The present invention discloses a display device and a manufacturing method therefor. The display device includes: a display screen, and a transparent cover plate provided above the display screen. The transparent cover plate includes an upper surface and two opposite side surfaces. The upper surface is connected with the two side surfaces to form a chamfer edge via chamfers respectively. The width of the transparent cover plate is not greater than that of the display screen.

### CROSS REFERENCE TO RELATED APPLICATIONS

This is a continuation application of International Patent Application No.: PCT/CN2015/087387, filed on Aug. 18, 2015, which claims priority to Chinese Patent Applications No.:201410419874.0 filed on Aug. 22, 2014 and No.: 201510496332.8 filed on Aug. 13, 2015, the disclosure of which is incorporated by reference herein in its entirety.

### TECHNICAL FIELD

The present invention relates to the technical field of terminals, and in particular to a display device, of which the flame is not easily visible in an edge portion, and a manufacturing method thereof.

### BACKGROUND

With the development of a display technology, various new display devices emerge continuously. A Liquid Crystal Display (LCD) has the advantages of small body thickness, power saving, no radiation and the like, and is widely applied to mobile terminal equipment. Most of LCDs in the current market are backlight-type LCDs. This type of LCD includes a rear housing, a front housing, a middle frame, a backlight module and a liquid crystal display panel. The backlight module is set on the rear housing. The middle frame is set on the backlight module, and supports the liquid crystal display panel. The front housing is configured to fix the liquid crystal display panel. The working principle of the liquid crystal display panel is that: liquid crystal molecules are placed between two parallel glass substrates, the directions of the liquid crystal molecules are controlled by energizing the glass substrates or not, and light of the backlight plate is refracted to generate an image.

With the continuous development of LCD production technology, in order to improve the user experience, frames of the LCDs tend to be manufactured more narrowly. In order to increase the sizes of the display screens of the mobile terminals while making the sizes of the mobile terminals not increased in proportion along with increase of the sizes of the display screens, it is necessary to design the frames of the display screens of the mobile terminals to be small or to even achieve the effect of frameless displaying. However, similar solutions are not proposed yet at present.

### SUMMARY

In view of this, in order to solve the existing technical problem, embodiments of the present invention provide a display device and a manufacturing method thereof, capable of enlarging, without increasing the size of a mobile terminal, a display area of the terminal so as to achieve the effect of frameless displaying.

To solve the above-mentioned technical problem, the technical solution is adopted in the embodiments of the present invention as follows.

According to a first aspect, the embodiments of the present invention provide a display device, which may include: a display screen, and a transparent cover plate provided above the display screen.

The transparent cover plate may include an upper surface and two opposite side surfaces. The upper surface may be connected with the two side surfaces respectively to form a chamfer edge via chamfers.

The width of the transparent cover plate may be not greater than that of the display screen.

In an embodiment of the present invention, the display screen may include a liquid crystal panel.

The transparent cover plate may be provided above the liquid crystal panel.

The liquid crystal panel may include a display area, the width of the display area being greater than or equal to that of the upper surface of the transparent cover plate.

In an embodiment of the present invention, the width of the display area may be equal to that of the transparent cover plate.

In an embodiment of the present invention, the display screen may further include a touch panel provided above the liquid crystal panel.

The width of the liquid crystal panel may be equal to that of the touch panel.

In an embodiment of the present invention, the display device may further include: a middle frame.

The middle frame may include a main plate and a side plate which are formed integrally, the main plate and the side plate being perpendicular to each other to form an accommodating space.

The transparent cover plate may be entirely or partially placed in the accommodating space.

In an embodiment of the present invention, the height of the transparent cover plate may be greater than that of the side plate.

In an embodiment of the present invention, the chamfer edge may include a circular arc segment and a straight line segment.

The straight line segment of the transparent cover plate may abut against the side plate, and the circular arc segment may be higher than the side plate.

In an embodiment of the present invention, the side plate may include a beveled edge, a tangent line of at least one point on the chamfer edge of the transparent cover plate passing through the beveled edge of the side plate.

In an embodiment of the present invention, the display device may further include: a backlight module.

A shading plate may be provided between the liquid crystal panel and the backlight module, the shading plate covering a periphery of the backlight module.

The width of the shading plate may be greater than or equal to a gap between the display area and the side plate, and the shading plate may shade the gap.

In an embodiment of the present invention, a flange for carrying the display screen may be provided on the inner side of the side plate.

The shading plate may be provided between the flange and the display screen, and may abut against the side plate.

In an embodiment of the present invention, the transparent cover plate may be made of glass or plastic.

In an embodiment of the present invention, the chamfer edge may be any one or a combination of: a folded line edge, an oblique edge, and a circular arc.

According to a second aspect, an embodiment of the present invention provides a display device, which may include: a liquid crystal panel, and a transparent cover plate provided above the liquid crystal panel.

The transparent cover plate may include an upper surface and two opposite side surfaces. The upper surface may be connected with the two side surfaces respectively to form a chamfer edge via chamfers.

Perpendicular light emitted from the liquid crystal panel may partially reach the chamfer edge of the transparent cover plate.

In an embodiment of the present invention, the transparent cover plate may further include a lower surface. The lower surface may include two side edges connected with the side surfaces. The perpendicular light emitted from the liquid crystal panel may partially reach the two side edges of the lower surface.

In an embodiment of the present invention, the display device may further include a touch panel provided above the liquid crystal panel.

The width of the liquid crystal panel may be equal to that of the touch panel.

In an embodiment of the present invention, the display device may further include: a backlight module.

A shading plate may be provided between the liquid crystal panel and the backlight module, the shading plate covering a periphery of the backlight module.

According to a third aspect, an embodiment of the present invention provides a manufacturing method for a display device, which may include the following steps.

A display screen and a transparent cover plate are provided, the transparent cover plate including an upper surface and two opposite side surfaces.

The transparent cover plate is provided above the display screen, and the width of the transparent cover plate is set to be not greater than that of the display screen.

The upper surface of the transparent cover plate is connected with the two side surfaces respectively to form a chamfer edge via chamfers, to make perpendicular light emitted from the display screen partially reach the chamfer edge of the transparent cover plate.

In an embodiment of the present invention, the display screen may include a liquid crystal panel.

The transparent cover plate may be provided above the liquid crystal panel.

The liquid crystal panel may include a display area, the width of the display area being greater than or equal to that of the upper surface of the transparent cover plate.

In an embodiment of the present invention, the width of the display area may be equal to that of the transparent cover plate.

In an embodiment of the present invention, the display screen may further include a touch panel provided above the liquid crystal panel.

The width of the liquid crystal panel may be equal to that of the touch panel.

Compared with the conventional art, the display device and the manufacturing method thereof according to the embodiments of the present invention have the advantages that the edge of the transparent cover plate is the chamfer edge, and light emitted from the backlight module is refracted by the chamfer edge of the transparent cover plate and emitted out from the position of the edge, thereby enlarging the display area. The middle frame is provided with the beveled edge along the direction of a light guide surface. Hence, from the perspective of a front direction perpendicular to the transparent cover plate, area of the extension direction of the entire transparent cover plate is all a visible area, i.e., the display range of the display screen extends to the edge of the display screen of a mobile terminal, thereby achieving the effect of frameless displaying. The shading plate shades display light emitted from the periphery of the backlight module, thereby preventing a user from feeling dizzy during viewing, enhancing the comfortable feeling of the user, and improving the experience. Thus, the embodiments of the present invention can solve the technical problem that a frame of a display screen of a mobile terminal is relatively wide.

### BRIEF DESCRIPTION OF THE DRAWINGS

FIG. 1 is a schematic structure diagram of a display device according to an embodiment of the present invention.

FIG. 2 is a schematic cross-section view of a transparent cover plate and display screen of a display device according to an embodiment of the present invention.

FIG. 3 is a schematic structure diagram of a liquid crystal panel of a display screen according to an embodiment of the present invention.

FIG. 4 is a schematic diagram of a size relation between a display screen, a transparent cover plate, an upper surface of a transparent cover plate and a display area according to an embodiment of the present invention.

FIG. 5 is a schematic cross-section view along the direction A-A in FIG. 1 in which a light transmission is also shown.

FIG. 6 is an exploded view of a display device according to an embodiment of the present invention.

FIG. 7 is a cross-section view of a transparent cover plate and display screen of a display device according to a further embodiment of the present invention.

FIG. 8 is a diagram of a size relation between a display screen, a transparent cover plate, an upper surface of a transparent cover plate and a display area according to a further embodiment of the present invention.

FIG. 9 is a light transmission diagram of a display device according to a preferred embodiment of the present invention.

FIG. 10 is a display effect diagram of a display device according to an embodiment of the present invention.

### DESCRIPTIONS OF REFERENCE SIGNS IN THE ACCOMPANYING DRAWINGS

110, transparent cover plate; 111, chamfer edge; 130, display screen;

131, touch panel; 132, liquid crystal panel; 133, backlight module;

140, middle frame; 141, main plate; 142, side plate;

1421, beveled edge; 160, shading plate; 161, flange.

### DETAILED DESCRIPTION

In order to make the technical problems to be solved by the present invention, the technical solution and the beneficial effects clearer, the present invention will be further elaborated hereinbelow in conjunction with the accompanying drawings and the embodiments. It should be understood that specific embodiments described herein are only intended to explain the present invention, and thus are not limitative of the present invention.

### Embodiment 1

Referring to FIG. 1 to FIG. 6, a display device of the embodiment of the present invention includes a transparent cover plate 110, a display screen 130 and a backlight module 133. The transparent cover plate 110 is provided above the display screen 130, and the display screen 130 is provided above the backlight module 133. The display screen 130 includes a touch panel 131 and a liquid crystal panel 132 provided adjacently in sequence from up to down. The liquid crystal panel 132 may also be replaced with an Organic Light Emitting Diode (OLED) panel, an electrowetting panel and other display panels. In addition, the display screen 130 may also only have a display function (only containing the liquid crystal panel) without a touch function (touch panel).

The transparent cover plate 110 includes an upper surface and two opposite side surfaces. The upper surface is connected with the two side surfaces to form a chamfer edge 111 respectively via chamfers. Thus, light generated by the backlight module 133 and then emitted out from the display screen 130, is partially emitted out directly from the upper surface of the transparent cover plate 110, and partially emitted out after being refracted by the chamfer edge 111 to enlarge a display area. The transparent cover plate 110 may be made of glass or plastic. The chamfer edge 111 may be a folded line edge, an oblique edge, a circular arc edge, a combination of circular arc and a straight line segment, or a combination of above various types.

Specifically, in the embodiment of the present invention, the transparent cover plate 110 includes an upper surface, a lower surface and two opposite side surfaces (with reference to an X axis direction, a left side surface and a right side surface), the lower surface being closer to the display screen 130. The left and right sides of the upper surface start to bend respectively to form a circular arc extending to approach two side edges of the lower surface of the display screen 130, that is, the upper surface of the transparent cover plate 110 is connected with the two side surfaces respectively to form the chamfer edge 111 via chamfers. The above description ‘start to bend to form the chamfer edge’ is a visual description, which should not be understood as an actual forming method for the chamfer edge 111. Certainly, the actual forming method for the chamfer edge is also not limited thereto. For example, it may be formed directly by using a chamfering manner.

In a preferred embodiment, when the left and right sides of the upper surface of the transparent cover plate 110 start to bend to form a circular arc extending to approach the lower surface, the circular arc is turned into a straight line or a folded line, and then intersected with the two side edges approaching the lower surface. Thus, the chamfer edge 111 including a combination of a straight line segment and a circular arc segment is formed.

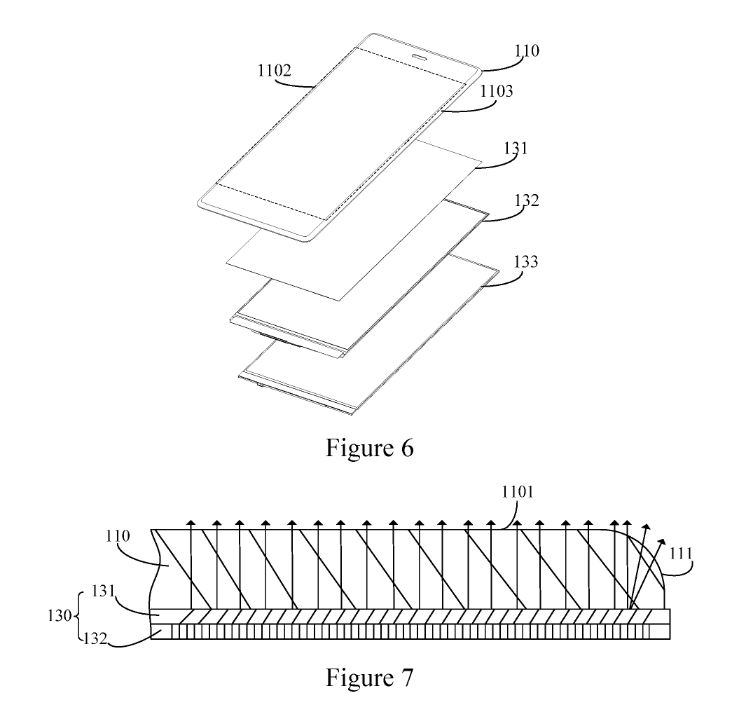

It should be understood that referring to FIG. 1, shaded areas shown in the figure are configured for setting a virtual key, a front camera, a receiver and others, and therefore it is not the display area of the terminal. Thus, portion of the transparent cover plate corresponding to the shaded areas does not need to include the chamfer edge, that is, the edge of the transparent cover plate corresponding to the shaded area may be a right-angled edge or other edges (referring to FIG. 6, it is only required that left and right opposite sides of the transparent cover plate of an area shown by dotted lines of the terminal). In order to make the terminal more beautiful and coordinated, the edge corresponding to the shaded area may also include the chamfer edge, that is, the periphery of the entire transparent cover plate includes the chamfer edges.

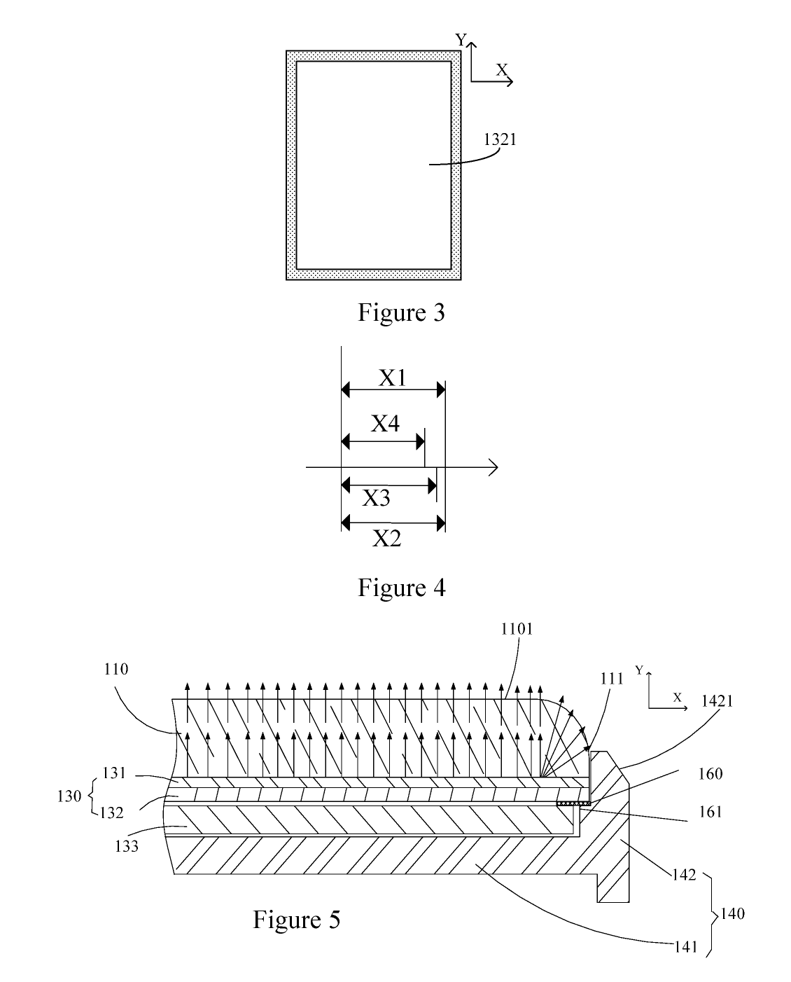

FIG. 3 shows a schematic structure diagram of a liquid crystal panel 132 according to an embodiment of the present invention. The liquid crystal panel 132 includes a display area (liquid crystal area) and a frame. The shaded area is the frame, and the other part is the display area.

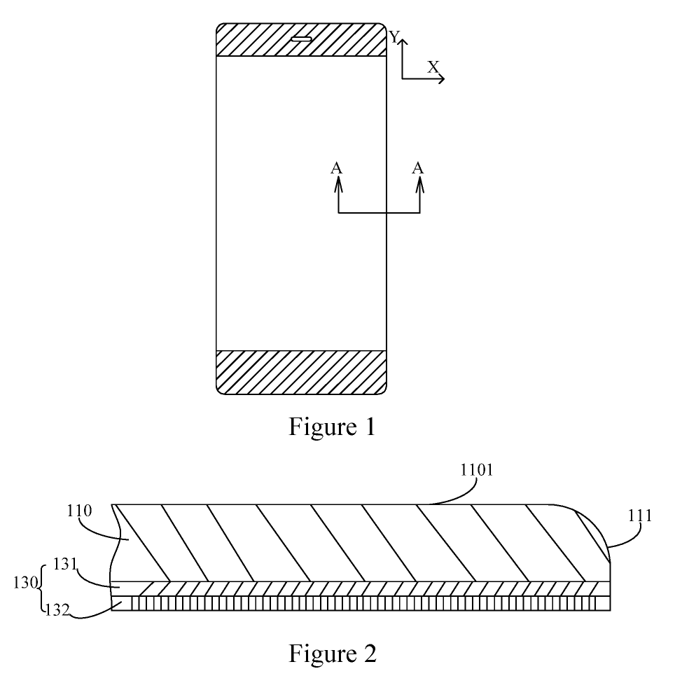

Referring to FIG. 2 and FIG. 4, in an embodiment of the present invention, in an X axis direction, the width (e.g., X1) of the transparent cover plate 110 is equal to the width of the display screen 130. That is, in the X axis direction, the width of the transparent cover plate 110 is equal to the width (e.g., X2) of the liquid crystal panel 132. X1=X2. The width (in X axis direction, e.g., X3) of the display area of the liquid crystal panel 132 is greater than or equal to the width (e.g., X4) of the upper surface of the transparent cover plate 110. That is, X3≧X4 (an equality relation is not shown in FIG. 4). The upper surface of the transparent cover plate 110 herein refers to a plane part of the upper surface of the transparent cover plate 110, excluding the part of the chamfer edge 111. FIG. 4 shows a size relation of X1-X4 in this embodiment. Thus, light emitted out from the backlight module 133 passes through the display area of the liquid crystal panel 132, and then is partially emitted out from the plane part of the transparent cover plate 110, and light at the edge of the display area is emitted out after being refracted by the chamfer edge 111 to enlarge a display area, thereby achieving an effect that the flame is not easily visible in an edge portion.

Referring to FIG. 2 again, the touch panel 132 and liquid crystal panel 131 of the display screen 130 are equal in width (in the X axis direction). Thus, the touch panel 132 extends to the part of the chamfer edge of the transparent cover plate 110, such that touch effect may be also generated by touching the chamfer edge 111 of the transparent cover plate 110. Thus, the touch experience of a user may be improved (for example, the screen brightness may be controlled by touching the chamfer edge 111 in conjunction with software design).

Referring to FIG. 5, the display device of the embodiment of the present invention further includes: a shading plate 160 and a middle frame 140. The shading plate 160 is provided between the liquid crystal panel 132 and backlight module 133 of the display screen 130. The display screen 130 and the transparent cover plate 110 are provided in the middle frame 140.

Referring to FIG. 5, the middle frame 140 includes a main plate 141 and a side plate 142. The main plate 141 is, preferably, a plate having a plane structure. Certainly, the structure is not limited to a strict plane structure, and may be an uneven structure. The main plate 141 and the side plate 142 are connected to form an accommodating space. The edge of the main plate 141 extends out at a certain angle (e.g., an obtuse angle, a right angle or an acute angle) to form the side plate 142. The above description that ‘the edge of the main plate 141 extends out at a certain angle to form the side plate 142’ is a visual description, which should not be understood as an actual forming method for the side plate 142. Certainly, the actual forming method for the side plate 142 is not limited thereto. The accommodating space is configured to hold or accommodate the display screen 130 and so on. The main plate 141 and the side plate 142 may be formed integrally, or they are connected together by means of buckles, screws, adhesives or other manners.

The side plate 142 includes a beveled edge 1421 such as a folded line edge or an arc edge, or is an oblique edge as shown in FIG. 5. The side plate 142 includes a first side surface close to the display screen 130 and a second side surface away from the display screen 130. The first side surface of the side plate 142 and the second side surface of the side plate 142 are parallel to each other. Alternatively the two sides are not limited to strict parallelism. Two ends of the beveled edge 1421 are respectively intersected with the first side surface of the side plate 142 and the second side surface of the side plate 142. Alternatively, as shown in FIG. 5, one end of the beveled edge 1421 is intersected with the second side surface of the side plate 142, and an extension line of the other end is intersected with the first side surface of the side plate 142.

The display screen 130 and the backlight module 133 are provided in the middle frame 140, that is, the display screen 130 and the backlight module 133 are placed in the accommodating space formed between the main plate 141 and the side plate 142.

The transparent cover plate 110 is entirely or partially placed in the accommodating space formed between the main plate 141 and the side plate 142. Certainly, the transparent cover plate 110 may also be provided outside the accommodating space formed between the main plate 141 and the side plate 142. As shown in FIG. 5, the transparent cover plate 110 is partially placed in the accommodating space formed between the main plate 141 and the side plate 142.

As above, if the chamfer edge 111 of the transparent cover plate 110 includes a circular arc segment and a straight line segment, the straight line segment abuts against the side plate 142, and the circular arc segment is higher than the side plate 142. With contact like this (surface contact as compared to point contact or line contact), the transparent cover plate 110 and the middle frame 140 can be well fixed.

With reference to the main plate 141 of the middle frame 140, the height of the transparent cover plate 110 is greater than that of the side plate 142.

A continuous structure design or a slope design of gradual expansion between the chamfer edge 111 of the transparent cover plate 110 and the beveled edge 1421 of the side plate 142 makes a product design satisfy the aesthetic feeling of an industrial design, and also makes the user have a mellow or smooth contact experience instead of a bad sharp touching experience during touch or grip.

A tangent line of at least one point on the chamfer edge 111 passes through the beveled edge 1421 of the side plate 142.

Referring to FIG. 5 again, the shading plate 160 covers a periphery of the backlight module 133 and shades the gap between the display area of the liquid crystal panel 132 and the side plate 152.

The width of the shading plate 160 is greater than or equal to the width of the gap, as long as display light emitted from the backlight module 133 cannot be leaked from the gap between the display area and the side plate 152.

A flange 161 for carrying the liquid crystal panel 132, the touch panel 131 and the transparent cover plate 110 is provided on the inner side of the side plate 152. The shading plate 160 is provided between the flange 161 and the liquid crystal panel 132, covers the periphery of the backlight module 140, and abuts against the side plate 152. That is, the right end of the shading plate 160 abuts against the side approaching the liquid crystal panel 132 on the side plate 152, to prevent light leakage.

As shown in FIG. 5, light generated by the backlight module 133 after passing through the liquid crystal panel 132 and the touch panel 131 and then penetrating through the transparent cover plate 110, is partially emitted out along the perpendicular direction of the transparent cover plate 110, and partially refracted by the chamfer edge 111 of the transparent cover plate 110 and emitted out from the chamfer edge. Due to the design of the chamfer edge, the display area is enlarged. Moreover, the middle frame 150 is provided with the beveled edge 1421 along the direction of the chamfer edge. Hence, from the perspective of a front direction perpendicular to the transparent cover plate 110, the area in extension direction of the entire transparent cover plate 110 is a visible area, i.e., the display range of the display screen 132 extends to the edge of the display screen of a mobile terminal, thereby achieving the effect of frameless displaying and improving the user experience.

The shading plate 160, provided between the liquid crystal panel 132 and the backlight module 133 and covering the periphery of the backlight module 133, is configured to shade display light emitted from the periphery of the backlight module 140, thereby avoiding light being emitted from the gap between the display area of the liquid crystal panel 132 and the side plate 152, such that the user cannot feel dizzy during viewing, thus enhancing the comfortable feeling of the user, and improving the user experience.

In the display device of the embodiment of the present invention, the main plate 151 and the side plate 152 are perpendicular to each other. The main plate 151 carries the backlight module 140 assembled in the middle frame 150. The side plate 152 is configured to fix the touch panel 131, the liquid crystal panel 132 and the backlight module 133, or is configured to fix the touch panel 131, the liquid crystal panel 132, the backlight module 133 and the transparent cover plate 110.

In the display device of the embodiment of the present invention, the main plate 151 and the side plate 152 are formed integrally. Integral forming achieves stability and avoids adhesion to make the appearance more attractive.

In the display device of the embodiment of the present invention, the width of the backlight module 133 is greater than the width of the display area of the liquid crystal panel 132, and is smaller than the width of the liquid crystal panel 132 (besides, the width of the backlight module 133 may be greater than the width of the liquid crystal panel 132, which is not limited in the embodiment of the present invention). The wider part of the backlight module 133 relative to the display area of the liquid crystal panel 132, is blocked by the shading plate 160 so as not to let light emitted out, thereby preventing the user from feeling dizzy during viewing, and improving the comfortable feeling and experience of the user.

The shading plate 160 is made of black plastic. The black plastic has the characteristics of low linear expansion coefficient and high temperature resistance, and cannot be deformed under the long-time irradiation of light.

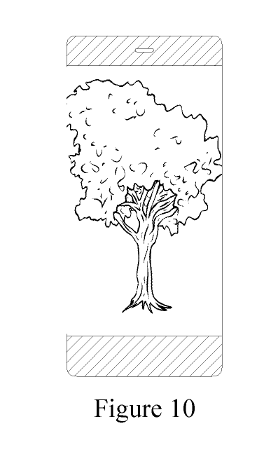

Optionally, the middle frame 150 is made of metal or plastic, such as copper (Cu), aluminum (Al), steel, stainless steel or magnesium. In the display device of the embodiment of the present invention, the transparent cover plate 110 has the chamfer edge 111, and light emitted from the backlight module 133 is refracted by the chamfer edge 111 of the transparent cover plate 110 and emitted out from the position of the chamfer edge 111, thereby enlarging the display area. The middle frame 150 of a display device having frameless effect is provided with the beveled edge 1421 along the direction of the circular arc edge 111, such that when the user views from a front perpendicular direction of the screen, the area in the extension direction of the transparent cover plate 110 is all a visible area, i.e., the display range of the liquid crystal panel 132 extends to the edge, thereby achieving the aim of a frameless displaying effect (FIG. 10 shows an achievable frameless display effect according to the embodiment of the present invention, and compared with the existing terminal, the display device of the embodiment of the present invention achieves true frameless displaying of the terminal). The shading plate 160 shades display light emitted from the periphery of the backlight module 133, thereby preventing the display light from being leaked from the gap between the display area and the side plate 152, such that the user cannot feel dizzy during viewing, thus enhancing the comfortable feeling of the user, and improving the user experience.

### Embodiment 2

Referring to FIG. 7, the embodiment 2 of the present invention is distinguished from the above-mentioned embodiment 1 in that: in the embodiment 2, the width (e.g., X1) of the transparent cover plate 110 in the embodiment 2 is smaller than the width of the display screen 130. That is, the width of the transparent cover plate 110 is smaller than the width (e.g., X2) of the liquid crystal panel 132. Perpendicular light emitted from the liquid crystal panel 131 may partially reach the chamfer edge 111 of the transparent cover plate 110 (referring to FIG. 7), so as to enlarge a display area to achieve the effect of frameless displaying.

Referring to FIG. 7, the display device of this embodiment includes a transparent cover plate 110 and a display screen 130. The transparent cover plate 110 is provided above the display screen 130. The display screen 130 includes a touch panel 131 and a liquid crystal panel 132 provided adjacently in sequence from up to down. The liquid crystal panel 132 may also be replaced with an OLED panel, an electrowetting panel and other display panels. In addition, the display screen 130 may also only have a display function (only containing the liquid crystal panel) without a touch function (touch panel).

The transparent cover plate 110 includes an upper surface and two opposite side surfaces. The upper surface is connected with the two side surfaces respectively to form a chamfer edge 111 via chamfers. Thus, light emitted out from the display screen 130 is partially directly emitted out from the upper surface of the transparent cover plate 110, and partially emitted out after being refracted by the chamfer edge 111 to thus enlarge a display area. The transparent cover plate 110 may be made of glass or plastic. The chamfer edge 111 may be a folded line edge, an oblique edge, a circular arc edge, a combination of circular arc and a straight line segment, or a combination of various types.

Specifically, the transparent cover plate 110 includes an upper surface, a lower surface and two opposite side surfaces (with reference to an X axis direction, a left side surface and a right side surface), the lower surface being closer to the display screen 130. The left and right sides of the upper surface start to bend respectively to form a circular arc extending to approach two side edges of the lower surface of the display screen 130, that is, the upper surface of the transparent cover plate 110 is connected with the two side surfaces respectively to form the chamfer edge 111 via chamfers. The above description ‘start to bend to form the chamfer edge’ is a visual description, which should not be understood as an actual forming method for the chamfer edge 111. Certainly, the actual forming method for the chamfer edge is not limited thereto. For example, it may be formed directly by using a chamfering manner.

In a preferred embodiment, when the left and right sides of the upper surface of the transparent cover plate 110 start to bend to form a circular arc extending to approach the lower surface, the circular arc is turned into a straight line or a folded line, and then intersected with the two side edges of the lower surface. Thus, the chamfer edge 111 including a combination of a straight line segment and a circular arc segment is formed.

It should be understood that referring to FIG. 1, a shaded area in the figure includes positions for virtual key, a front camera, a receiver and others, and therefore it is not the display area of the terminal. Thus, the transparent cover plate corresponding to the shaded area does not need to include the chamfer edge, that is, the edge of the transparent cover plate corresponding to the shaded area may be a right-angled edge or other edges (referring to FIG. 6, it is only required that left and right opposite sides of the transparent cover plate of an area shown by dotted lines of the terminal have chamfer edges). In order to make the terminal more beautiful and coordinated, the edge corresponding to the shaded area may also include the chamfer edge, that is, the periphery of the entire transparent cover plate includes the chamfer edges.

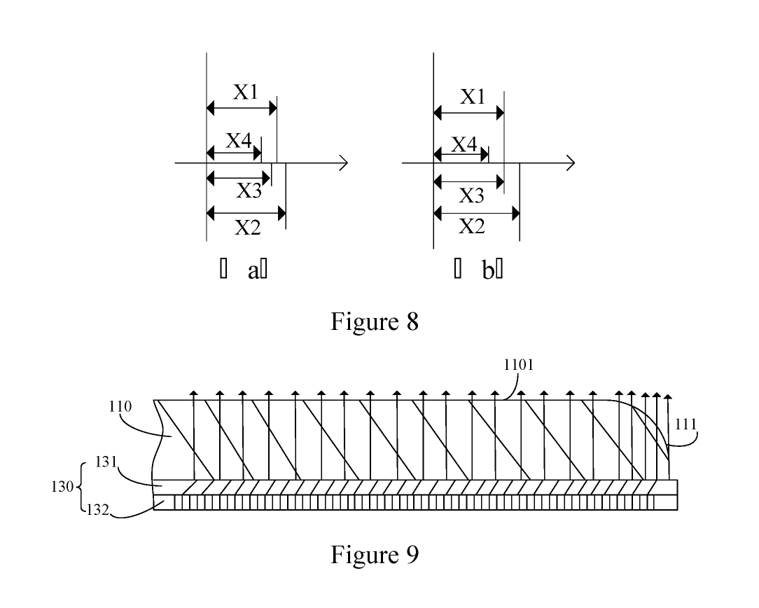

Referring to FIG. 7 and FIG. 8, in this embodiment, in an X axis direction, the width (e.g., X1) of the transparent cover plate 110 is smaller than the width of the display screen 130. That is, in the X axis direction, the width of the transparent cover plate 110 is smaller than the width (e.g., X2) of the liquid crystal panel 132. That is, X1<X2. The width (in the X axis direction, e.g., X3) of the display area of the liquid crystal panel 132 is greater than or equal to the width (e.g., X4) of the upper surface of the transparent cover plate 110. That is, X3≧X4 (an equality relation is not shown in FIG. 8). The upper surface of the transparent cover plate 110 herein refers to a plane part of the upper surface of the transparent cover plate 110, excluding the part of the chamfer edge 111. Thus, light emitted out from the backlight module 133 after passing through the display area of the liquid crystal panel 132, is partially emitted out from the plane part of the transparent cover plate 110, and light at the edge of the display area is emitted out after being refracted by the chamfer edge 111 to enlarge a display area, thereby achieving a true frameless effect.

In FIG. 8, (a) shows a size relation of X1-X4. In a preferred embodiment, as shown in right (b) of FIG. 8, the width X1 of the transparent cover plate 110 is equal to the width X3 of the display area of the liquid crystal panel 132, that is X1=X3, to achieve the effect of frameless displaying. Thus, referring to FIG. 9, perpendicular light emitted from the liquid crystal panel 131 may partially reach the side edge of the lower surface of the transparent cover plate 110 (the lower surface of the transparent cover plate 110 includes two side edges connected with the side surfaces of the transparent cover plate 110).

Referring to FIG. 7 again, the touch panel 132 and liquid crystal panel 131 of the display screen 130 are equal in width (in the X axis direction). Thus, the touch panel 132 extends to the part of the chamfer edge of the transparent cover plate 110, such that a touch effect may be generated by touching the chamfer edge 111 of the transparent cover plate 110. Thus the touch experience of a user may be improved (for example, the screen brightness may be controlled by touching the chamfer edge 111 in conjunction with software design).

It should be understood that the display device of the embodiment of the present invention further includes a backlight module, a shading plate and the like, identical to the above-mentioned embodiment in structure and function, which will not be elaborated herein. Besides, the display device of the embodiment of the present invention further includes a middle frame, identical to the above-mentioned embodiment in structure and function. It is only necessary to make the middle frame configurable to accommodate the transparent cover plate, the display screen and the backlight module, and the structure thereof will not be elaborated herein.

In the display device of the embodiment of the present invention, since the transparent cover plate 110 has the chamfer edge 111, light emitted from the backlight module 133 is refracted by the chamfer edge 111 of the transparent cover plate 110 and is emitted out from the position of the chamfer edge 111, thereby enlarging the display area. The middle frame 150 of a frameless display device is provided with the beveled edge 1421 along the direction of the circular arc edge 111, such that when the user views from a front perpendicular direction of the screen, the area in the extension direction of the transparent cover plate 110 is all a visible area, i.e., the display range of the liquid crystal panel 132 extends to the edge, thereby achieving the aim of a frameless displaying effect (FIG. 10 shows an achievable frameless display effect according to an embodiment of the present invention, and compared with the existing terminal, the display device of the embodiment of the present invention achieves true frameless displaying of the terminal).

### Embodiment 3

On the basis of the above-mentioned embodiments, correspondingly, an embodiment of the present invention also provides a manufacturing method for a display device, which includes the following steps.

Step S1: A display screen and a transparent cover plate are provided, the transparent cover plate including an upper surface and two opposite side surfaces.

Step S2: The transparent cover plate is provided above the display screen, and the width of the transparent cover plate is set to be not greater than that of the display screen.

Step S3: The upper surface of the transparent cover plate is connected with the two side surfaces respectively to form a chamfer edge via chamfers, to make the light emitted from the display screen partially emitted out from the upper surface of the transparent cover plate and partially emitted out by the refraction of the chamfer edge of the transparent cover plate.

The display screen includes a liquid crystal panel. The transparent cover plate is provided above the display screen. The liquid crystal panel includes a display area, the width of the display area being greater than or equal to that of the upper surface of the transparent cover plate.

The display screen further includes a touch panel provided above the liquid crystal panel, and the width of the liquid crystal panel is equal to that of the touch panel.

The method according to the embodiment of the present invention further includes that: a middle frame is provided. The middle frame includes a main plate and a side plate which are formed integrally, the main plate and the side plate being perpendicular to each other to form an accommodating space. The transparent cover plate is entirely or partially placed in the accommodating space. The display screen is placed in the accommodating space. The height of the transparent cover plate is greater than that of the side plate. The chamfer edge includes a circular arc segment and a straight line segment, the straight line segment of the transparent cover plate abuts against the side plate, and the circular arc segment is higher than the side plate. The side plate includes a beveled edge. A tangent line of at least one point on the chamfer edge of the transparent cover plate passes through the beveled edge of the side plate.

The method according to the embodiment of the present invention further includes that: a backlight module and a shading plate are provided, and the shading plate is provided between the liquid crystal panel and the backlight module, the shading plate covering a periphery of the backlight module. The width of the shading plate is greater than or equal to a gap between the display area and the side plate, and the shading plate shades the gap. A flange for carrying the display screen is provided on the inner side of the side plate. The shading plate is provided between the flange and the display screen, and abuts against the side plate.

It should be understood that the manufacturing method of the embodiment of the present invention may be used for manufacturing the display device of the above-mentioned embodiment, the structure thereof is detailed in the above-mentioned embodiment, and the above-mentioned structure of the display device will not be elaborated herein. The manufacturing method according to the embodiment of the present invention includes an additional implementation, in which functions may not be executed in a shown or discussed sequence, and can be executed in a substantially simultaneous manner or in an opposite sequence of the shown or discussed sequence. This should be understood by those skilled in the art of the embodiment of the present invention.

In the display device and the manufacturing method thereof in the embodiments of the present invention, the transparent cover plate 110 has the chamfer edge 111, and light emitted from the backlight module 133 is refracted by the chamfer edge 111 of the transparent cover plate 110 and emitted out from the position of the chamfer edge 111, thereby enlarging the display area. The middle frame 150 of a frameless display device is provided with the beveled edge 1421 along the direction of the circular arc edge 111, such that when the user views from a front perpendicular direction of the screen, the area in the extension direction of the transparent cover plate 110 is all a visible area, i.e., the display range of the liquid crystal panel 132 extends to the edge, thereby achieving the aim of a frameless displaying effect. The shading plate 160 shades display light emitted from the periphery of the backlight module 133, thereby preventing the display light from being leaked from the gap between the display area and the side plate 152, such that the user cannot feel dizzy during viewing, thus enhancing the comfortable feeling of the user, and improving the user experience.

Preferred embodiments of the present invention are described above with reference to the accompanying drawings, and the scope of protection of the present invention is not limited accordingly. Those skilled in the art may implement the present invention by various transformed solutions without departing from the scope and essence of the present invention. For example, features of an embodiment may be applied to another embodiment to obtain a further embodiment. Any modifications, equivalent replacements and improvements made within the application of the technical concept of the present invention should fall within the protection scope of the present invention.

### INDUSTRIAL APPLICABILITY

The display device in each embodiment of the present invention includes: a display screen, and a transparent cover plate provided above the display screen. The transparent cover plate includes an upper surface and two opposite side surfaces. The upper surface is connected with the two side surfaces respectively to form a chamfer edge via chamfers. The width of the transparent cover plate is not greater than that of the display screen. Thus, the terminal provided by the embodiments of the present invention can enlarge a display area of the terminal and achieve the effect of frameless displaying. Therefore, when using the terminal provided by the embodiments of the present invention, a user cannot feel dizzy, thereby enhancing the comfortable feeling of the user, and improving the user experience.

What is claimed is:

1. A display device, comprising: a display screen, and a transparent cover plate provided above the display screen, wherein p1 the transparent cover plate comprises an upper surface and two opposite side surfaces, and the upper surface is connected with the two side surfaces respectively to form a chamfer edge via chamfers; and
the width of the transparent cover plate is not greater than that of the display screen.

2. The display device according to claim 1, wherein the display screen comprises a liquid crystal panel;
the transparent cover plate is provided above the liquid crystal panel; and
the liquid crystal panel comprises a display area, the width of the display area being greater than or equal to that of the upper surface of the transparent cover plate.

3. The display device according to claim 2, wherein the width of the display area is equal to that of the transparent cover plate.

4. The display device according to claim 2, wherein the display screen further comprises a touch panel provided above the liquid crystal panel; and
the width of the liquid crystal panel is equal to that of the touch panel.

5. The display device according to claim 1, further comprising: a middle frame, wherein
the middle frame comprises a main plate and a side plate which are formed integrally, the main plate and the side plate being perpendicular to each other to form an accommodating space; and
the transparent cover plate is entirely or partially placed in the accommodating space.

6. The display device according to claim 5, wherein the height of the transparent cover plate is greater than that of the side plate.

7. The display device according to claim 5, wherein the chamfer edge comprises a circular arc segment and a straight line segment; and
the straight line segment of the transparent cover plate abuts against the side plate, and the circular arc segment is higher than the side plate.

8. The display device according to claim 5, wherein the side plate comprises a beveled edge, a tangent line of at least one point on the chamfer edge of the transparent cover plate passing through the beveled edge of the side plate.

9. The display device according to claim 5, further comprising: a backlight module, wherein
a shading plate is provided between the liquid crystal panel and the backlight module, the shading plate covering a periphery of the backlight module; and
the width of the shading plate is greater than or equal to a gap between the display area and the side plate, and the shading plate shades the gap.

10. The display device according to claim 9, wherein a flange for carrying the display screen is provided on the inner side of the side plate; and
the shading plate is provided between the flange and the display screen, and abuts against the side plate.

11. The display device according to claim 1, wherein the transparent cover plate is made of glass or plastic.

12. The display device according to claim 1, wherein the chamfer edge is any one or a combination of: a folded line edge, an oblique edge, and a circular arc.

13. A display device, comprising: a liquid crystal panel, and a transparent cover plate provided above the liquid crystal panel, wherein
the transparent cover plate comprises an upper surface and two opposite side surfaces, and the upper surface is connected with the two side surfaces respectively to form a chamfer edge via chamfers; and
perpendicular light emitted from the liquid crystal panel partially reaches the chamfer edge of the transparent cover plate.

14. The display device according to claim 13, wherein the transparent cover plate further comprises a lower surface, the lower surface comprises two side edges connected with the side surfaces, and the perpendicular light emitted from the liquid crystal panel partially reaches the two side edges of the lower surface.

15. The display device according to claim 13, further comprising a touch panel provided above the liquid crystal panel, wherein
the width of the liquid crystal panel is equal to that of the touch panel.

16. The display device according to claim 13, further comprising: a backlight module, wherein
a shading plate is provided between the liquid crystal panel and the backlight module, the shading plate covering a periphery of the backlight module.

17. A manufacturing method for a display device, comprising:
providing a display screen and a transparent cover plate, the transparent cover plate comprising an upper surface and two opposite side surfaces;
providing the transparent cover plate above the display screen, and setting the width of the transparent cover plate to be not greater than that of the display screen; and
connecting the upper surface of the transparent cover plate with the two side surfaces respectively to form a chamfer edge via chamfers, to make perpendicular light emitted from the display screen partially reach the chamfer edge of the transparent cover plate.

18. The method according to claim 17, wherein the display screen comprises a liquid crystal panel;
the transparent cover plate is provided above the liquid crystal panel; and
the liquid crystal panel comprises a display area, the width of the display area being greater than or equal to that of the upper surface of the transparent cover plate.

19. The method according to claim 18, wherein the width of the display area is equal to that of the transparent cover plate.

20. The method according to claim 18, wherein the display screen further comprises a touch panel provided above the liquid crystal panel; and
the width of the liquid crystal panel is equal to that of the touch panel.
